(19) United States
(12) Patent Application Publication
(10) Pub. No.: US 2018/0331793 A9
(43) Pub. Date: Nov. 15, 2018

(54) COMPLIANCE TEST APPARATUS AND METHOD FOR A COMMUNICATION NODE

(71) Applicant: Hyundai Motor Company, Seoul (KR)

(72) Inventors: Sung Ho Choi, Suwon (KR); Woo Sub Kim, Namyangju (KR); Seong Jin Park, Suwon (KR)

(21) Appl. No.: 15/259,346

(22) Filed: Sep. 8, 2016

(30) Foreign Application Priority Data
Sep. 8, 2015 (KR) 10-2015-0127109

(51) Int. Cl. H04L 1/24; H04L 29/08; G06F 11/22; G06F 11/273

(52) U.S. Cl. CPC H04L 1/245; G06F 11/2733; G06F 11/2205; H04L 67/12

(57) ABSTRACT

A method for a compliance test on a communication node, performed in a gateway constituting a vehicle network of a vehicle, may include: receiving a test mode request signal for the compliance test on the communication node; transmitting the test mode request signal to the communication node on which the compliance test is performed; receiving an output signal according to the test mode request signal from the communication node; and transmitting the received output signal to a fixture connected to a test apparatus which performs the compliance test on the communication node.

### CROSS-REFERENCE TO RELATED APPLICATIONS

This application claims the benefit of and priority to Korean Patent Application No. 10-2015-0127109 filed on Sep. 8, 2015 in the Korean Intellectual Property Office (KIPO), the entire contents of which are hereby incorporated by reference as if fully set forth herein.

### BACKGROUND

1. Technical Field

The present disclosure relates generally to compliance test technologies for a communication node constituting a vehicle network, and more specifically, to a technique for performing a compliance test for a communication node as equipped in a vehicle.

2. Description of the Related Art

Along with the rapid digitalization of vehicle parts, the number and variety of electronic devices installed within a vehicle have been increasing significantly. Electronic devices may currently be used throughout the vehicle, such as in a power train control system, a body control system, a chassis control system, a vehicle network, a multimedia system, and the like. For instance, the power train control system may include an engine control system, an automatic transmission control system, etc. The body control system may include a body electronic equipment control system, a convenience apparatus control system, a lamp control system, etc. The chassis control system may include a steering apparatus control system, a brake control system, a suspension control system, etc. The vehicle network may include a controller area network (CAN), a FlexRay-based network, a media oriented system transport (MOST)-based network, etc. The multimedia system may include a navigation apparatus system, a telematics system, an infotainment system, etc.

Such systems and electronic devices constituting each of the systems are connected via the vehicle network, which supports functions of the electronic devices. For instance, the CAN may support a transmission rate of up to 1 Mbps and may support automatic retransmission of colliding messages, error detection-based on a cycle redundancy interface (CRC), etc. The FlexRay-based network may support a transmission rate of up to 10 Mbps and may support simultaneous transmission of data through two channels, synchronous data transmission, etc. The MOST-based network is a communication network for high-quality multimedia, which may support a transmission rate of up to 150 Mbps.

Meanwhile, the telematics system and the infotainment system, as well as enhanced safety systems of a vehicle, require higher transmission rates and system expandability. However, the CAN, FlexRay-based network, or the like may not sufficiently support such requirements. The MOST-based network may support a higher transmission rate than the CAN and the FlexRay-based network. However, costs increase to apply the MOST-based network to all vehicle networks. Due to these limitations, an Ethernet-based network may be considered a vehicle network. The Ethernet-based network may support bi-directional communication through one pair of windings and may support a transmission rate of up to 10 Gbps.

The CAN network, which is widely used as a vehicle network, uses a bus-type topology. Accordingly, a network compliance test can be performed through measurements on transmit/receive messages for communication nodes connected to the network. Meanwhile, the Ethernet-based network uses a switch-based network topology.

Generally, a compliance test on a communication node is performed as the communication node is a component before installment in a vehicle. For this, a communication node in a component state is connected to a predetermined fixture, and a test apparatus (e.g., an oscilloscope, etc.) for the compliance test is connected to the fixture through a cable. Then, a signal for each test mode according to the compliance test is received at the fixture from the communication node, and the fixture transmits the received signal to the test apparatus through the cable. Then, the test apparatus outputs results from the signal provided from the fixture.

As such, the compliance test method is performed on a communication node in the component state. That is, in order to perform a compliance test on a communication node which has been already installed in a vehicle, after disassembling the vehicle and removing connectors for the communication node, a fixture and a test apparatus should be directly connected to the communication node, and the compliance test should be performed on the communication node. Therefore, a method and an apparatus for performing in-vehicle network compliance tests for a physical layer, etc. of communication nodes is required.

### SUMMARY

Accordingly, embodiments of the present disclosure are provided to substantially obviate one or more problems due to limitations and disadvantages of the related art.

Embodiments of the present disclosure provide compliance test methods for a communication node in a vehicle network, which can perform a compliance test on the communication node as the communication node is installed in a vehicle.

In accordance with the embodiments of the present disclosure, a method for a compliance test on a communication node, performed in a gateway constituting a vehicle network of a vehicle, includes: receiving a test mode request signal for the compliance test on the communication node; transmitting the test mode request signal to the communication node on which the compliance test is performed; receiving an output signal according to the test mode request signal from the communication node; and transmitting the received output signal to a fixture connected to a test apparatus which performs the compliance test on the communication node.

The test mode request signal may include identification information of the communication node, and the test mode request signal may be transmitted to the communication node according to the identification information of the communication node.

When the communication node is connected to another gateway that is connected to the gateway, the test mode request signal may be transmitted to the communication node through the other gateway.

The test mode request signal may include mode type information indicating a type of the compliance test. Also, the mode type information may include a code value to be configured in a register of the communication node. Also, the gateway may receive an output signal corresponding to the mode type information from the communication node, and transmit the received output signal to the fixture. Also, the output signal may include test symbols corresponding to the mode type information.

The compliance test may be performed as the communication node is installed in the vehicle.

Furthermore in accordance with the embodiments of the present disclosure, a method for a compliance test on a communication node constituting a vehicle network of a vehicle includes: receiving a test mode request signal for the compliance test on the communication node from a gateway; generating an output signal according to the received test mode request signal; and transmitting the generated output signal to the gateway.

The generated output signal may correspond to mode type information included in the test mode request signal. Also, the mode type information may include a code value to be configured in a register of the communication node.

The compliance test is performed as the communication node is installed in the vehicle.

Furthermore, in accordance with the embodiments of the present disclosure, a method for a compliance test on a communication node, performed in a gateway constituting a vehicle network of a vehicle includes: receiving a test mode request signal for the compliance test on the communication node; transmitting the received test mode request signal respectively to at least one communication node connected to the gateway on which the compliance test is performed; receiving an output signal according to the test mode request signal from the at least one communication node which received the test mode request signal; and transmitting the received output signal to a fixture connected to a test apparatus which performs the compliance test on the communication node.

When the at least one communication node may be connected to another gateway that is connected to the gateway, the test mode request signal is transmitted to the at least one communication node through the other gateway.

The test mode request signal may include mode type information indicating a type of the compliance test. Also, the mode type information may include a code value to be configured in a register of the communication node.

Furthermore, in accordance with the embodiments of the present disclosure, a method for a compliance test on a communication node constituting a vehicle network of a vehicle includesybb: determining whether a test mode request signal transmitted from a gateway designates the communication node; identifying the test mode request signal when the test mode request signal designates the communication node; generating an output signal according to the identified test mode request signal; and transmitting the generated output signal to the gateway.

The communication node may determine whether the test mode request signal designates the communication node based on identification information included in the test mode request signal.

The generated output signal may correspond to mode type information included in the test mode request signal. Also, the mode type information may include a code value to be configured in a register of the communication node.

According to embodiments of the present disclosure, a compliance evaluation on a communication node can be performed not as the node is a component which is not installed in a vehicle, but as the node is installed in a vehicle. Accordingly, without any connection bridge, the compliance test can be performed on the communication node easily without disassembling the vehicle.

### BRIEF DESCRIPTION OF DRAWINGS

Embodiments of the present disclosure will become more apparent by describing in detail embodiments of the present disclosure with reference to the accompanying drawings, in which:

FIG. 1 is a diagram illustrating a vehicle network topology according to embodiments of the present disclosure;

FIG. 2 is a diagram illustrating a communication node constituting a vehicle network according to embodiments of the present disclosure;

FIG. 3 is a sequence chart illustrating a compliance test method in a gateway and a communication node constituting a vehicle network according to embodiments of the present disclosure;

FIG. 4 is a sequence chart illustrating an additional compliance test method in a gateway and a communication node constituting a vehicle network according to embodiments of the present disclosure;

FIG. 5 is a sequence chart illustrating an additional compliance test method in a gateway and a communication node constituting a vehicle network according to embodiments of the present disclosure; and

FIG. 6 is a sequence chart illustrating an additional compliance test method in a gateway constituting a vehicle network according to embodiments of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Although embodiments are described herein as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules, and the processor is specifically configured to execute said modules to perform one or more processes which are described further below. Moreover, it is understood that the units or modules described herein may embody a controller/control unit for controlling operation of the unit or module.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several embodiments, specific embodiments will be shown in the accompanying drawings and be described in detail in the detailed description. It should be understood, however, that it is not intended to limit the present disclosure to the specific embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term ‘and/or’ means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms such as terms that are generally used and have been in dictionaries should be construed as having meanings matched with contextual meanings in the art. In this description, unless defined clearly, terms are not ideally, excessively construed as formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

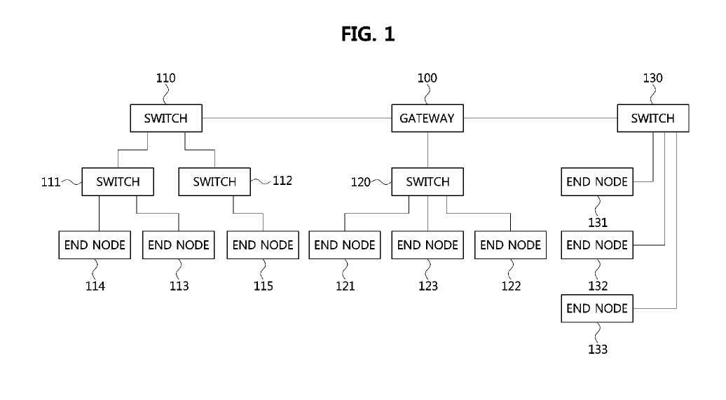

FIG. 1 is a diagram showing a vehicle network topology according to embodiments of the present disclosure.

As shown in FIG. 1, a communication node may include a gateway, a switch (or bridge), or an end node. The gateway 100 may be connected with at least one switch 110, 110-1, 110-2, 120, and 130 and may be configured to connect different networks. For example, the gateway 100 may connect a switch that supports a controller area network (CAN) (e.g., FlexRay, media oriented system transport (MOST), or local interconnect network (LIN)) protocol and a switch that supports an Ethernet protocol. Each of the switches 110, 110-1, 110-2, 120, and 130 may be connected with at least one end nodes 111, 112, 113, 121, 122, 123, 131, 132, and 133. Each of the switches 110, 110-1, 110-2, 120, and 130 may interconnect the end nodes 111, 112, 113, 121, 122, 123, 131, 132, and 133, and operate at least one of end nodes connected to the switch.

The end nodes 111, 112, 113, 121, 122, 123, 131, 132, and 133 may include an electronic control unit (ECU) configured to operate various types of devices mounted within a vehicle. For example, the end nodes 111, 112, 113, 121, 122, 123, 131, 132, and 133 may include an ECU configured to operate an infotainment device (e.g., a display device, a navigation device, and an around view monitoring device).

Communication nodes (e.g., a gateway, a switch, an end node, or the like) included in a vehicle network may be connected in a star topology, bus topology, ring topology, tree topology, mesh topology, etc. In addition, the communication nodes of the vehicle network may support a CAN protocol, FlexRay protocol, MOST protocol, LIN protocol, or Ethernet protocol. Exemplary embodiments of the present disclosure may be applied to the above-described network topologies. The network topology to which exemplary embodiments of the present disclosure may be applied is not limited thereto and may be configured in various ways.

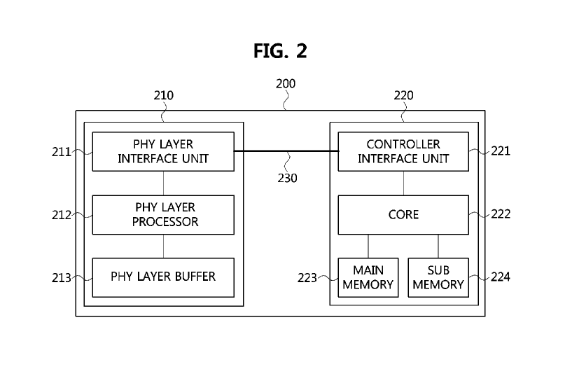

FIG. 2 is a diagram showing a communication node constituting a vehicle network according to embodiments of the present disclosure. Notably, the various methods discussed herein below may be executed by a controller having a processor and a memory, as described above.

As shown in FIG. 2, a communication node 200 of a network may include a PHY layer block 210 and a controller 220. In addition, the communication node 200 may further include a regulator (not shown) for supplying power. In particular, the controller 220 may be implemented to include a medium access control (MAC) layer. A PHY layer block 210 may be configured to receive or transmit signals from or to another communication node. The controller 220 may be configured to operate the PHY layer block 210 and perform various functions (e.g., an infotainment function). The PHY layer block 210 and the controller 220 may be implemented as one system on chip (SoC) or alternatively, may be implemented as separate chips.

Further, the PHY layer block 210 and the controller 220 may be connected via a media independent interface (MII) 230. The MII 230 may include an interface defined in the IEEE 802.3 and may include a data interface and a management interface between the PHY layer block 210 and the controller 220. One of a reduced MII (RMII), a gigabit MII (GMII), a reduced GMII (RGMII), a serial GMII (SGMII), a 10 GMII (XGMII) may be used instead of the MII 230. A data interface may include a transmission channel and a reception channel, each of which may have an independent clock, data, and a control signal. The management interface may include a two-signal interface, one signal for the clock and one signal for the data.

Particularly, the PHY layer block 210 may include a PHY layer interface unit 211, a PHY layer processor 212, and a PHY layer memory 213. The configuration of the PHY layer block 210 is not limited thereto, and the PHY layer block 210 may be configured in various ways. The PHY layer interface unit 211 may be configured to transmit a signal received from the controller 220 to the PHY layer processor 212 and transmit a signal received from the PHY layer processor 212 to the controller 220. The PHY layer processor 212 may be configured to execute operations of the PHY layer interface unit 211 and the PHY layer memory 213. The PHY layer processor 212 may be configured to modulate a signal to be transmitted or demodulate a received signal. The PHY layer processor 212 may be configured to operate the PHY layer memory 213 to input or output a signal. The PHY layer memory 213 may be configured to store the received signal and output the stored signal based on a request from the PHY layer processor 212.

The controller 220 may be configured to monitor and operate the PHY layer block 210 using the MII 230. The controller 220 may include a controller interface 221, a controller processor 222, a main memory 223, and a sub memory 224. The configuration of the controller 220 is not limited thereto, and the controller 220 may be configured in various ways. The controller interface 221 may be configured to receive a signal from the PHY layer block 210 (e.g., the PHY layer interface 211) or an upper layer (not shown), transmit the received signal to the controller processor 222, and transmit the signal received from the controller processor 222 to the PHY layer block 210 or upper layer. The controller processor 222 may further include an independent memory control logic or an integrated memory control logic for operating the controller interface 221, the main memory 223, and the sub memory 224. The memory control logic may be implemented to be included in the main memory 223 and the sub memory 224 or may be implemented to be included in the controller processor 222.

Furthermore, each of the main memory 223 and the sub memory 224 may be configured to store a signal processed by the controller processor 222 and may be configured to output the stored signal based on a request from the controller processor 222. The main memory 223 may be a volatile memory (e.g., a random access memory (RAM)) configured to temporarily store data required for the operation of the controller processor 222. The sub memory 224 may be a non-volatile memory in which an operating system code (e.g., a kernel and a device driver) and an application program code for performing a function of the controller 220 may be stored. A flash memory having a high processing speed or a hard disc drive (HDD) or a compact disc-read only memory (CD-ROM) for large capacity data storage may be used as the non-volatile memory. Typically, the controller processor 222 may include a logic circuit having at least one processing core. A core of an Advanced RISC Machines (ARM) family or a core of an Atom family may be used as the controller processor 222.

Hereinafter, operation methods of a communication node belonging to a vehicle network and a counterpart communication node corresponding to the communication node will be described. However, even in a case that only an operation of a first communication node (e.g., transmission or reception of signals) is explained, a second communication node, a counterpart communication node corresponding to the first communication node, may perform a counter-operation (e.g., reception or transmission of signals) corresponding to the operation of the first communication node.

That is, even when only an operation of the first communication node is explained, it should be understood that the second communication node corresponding to the first communication node can perform a counter-operation of the operation of the first communication node. On the contrary, even when an operation of the second communication node is explained, it should be understood that the first communication node corresponding to the second communication node can perform a counter-operation of the operation of the second communication node.

Embodiments of the present disclosure can evaluate the reliability of a physical layer of a communication node as the communication is installed in a vehicle. Once a gateway including an Ethernet switch or the like receives a test mode request signal for a compliance test on a communication node from a computer or a test apparatus, the gateway may transmit the test mode request signal to a communication corresponding to identification information included in the received test mode request signal. Upon receiving the test mode request signal, the communication node is transitioned to a compliance test mode, and generates an output signal according to the test mode request signal. For example, various types of test modes may include, as physical layer tests, ‘Droop’ test, ‘jitter test in master mode’, ‘jitter test in slave mode’, ‘distortion test’, and ‘power spectral density (PSD) test’, etc. The communication node transmits the generated output signal to a gateway. The gateway transmits the output signal to a fixture, and the fixture transmits the output signal to a test apparatus (e.g., an oscilloscope, etc.) connected through a cable. The fixture may transmit the output signal to the test apparatus through a serial cable having a large bandwidth such as Serial Advanced Technology Attachment (SATA), Peripheral Component Interconnect express (PCIe), Universal Serial Bus (USB) 3.0, etc. The test apparatus outputs a result for each test mode for the compliance tests based on the output signal received from the fixture.

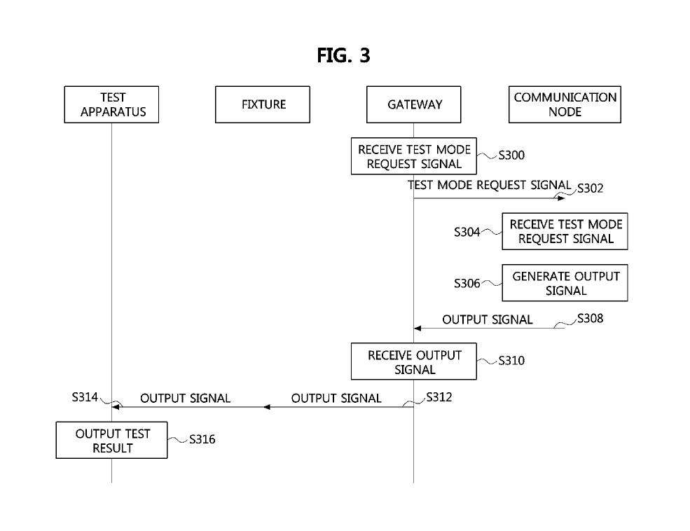

FIG. 3 is a sequence chart illustrating a first exemplary embodiment of a compliance test method in a gateway and a communication node constituting a vehicle network according to embodiments of the present disclosure.

As shown in FIG. 3, a compliance test method using a single gateway is illustrated. The gateway may receive a test mode request signal for a compliance test on a communication node (S300). The test mode request signal is a signal for requesting a compliance test on a physical layer, etc. of the communication node installed in a vehicle. The test mode request signal may be received from a computer or a test apparatus for the compliance test which is connected to the gateway. The gateway may receive the test mode request signal through a network based on CAN protocol, FlexRay protocol, MOST protocol, or Ethernet protocol. Also, the gateway may receive the test mode request signal by using a communication manner such as a diagnostic communication over Internet Protocol (DoIP), Service Oriented Middleware over Internet Protocol (SOME/IP), etc.

After the step S300, the gateway may transmit the test mode request signal to a communication node corresponding to the received test mode request signal (S302). The gateway may transmit the test mode request signal to the communication node by using a communication manner such as DoIP or SOME/IP.

The test mode request signal may include identification information of a communication node on which the compliance test is to be performed among a plurality of communication nodes connected to the gateway. The identification information of the communication node may be included in header information of the test mode request signal. In order to transmit the test mode request signal to the communication node corresponding to the identification information, the gateway may store table information for communication nodes and identification information corresponding to the communication nodes. Table 1 below shows an example of identification information for communication nodes connected to the gateway.

TABLE 1

| Communication port | Identification Information |
|---|---|
| 1 | 0x10 |
| 2 | 0x20 |
| 3 | 0x30 |
| 4 | 0x40 |

For example, if the test mode request signal received by the gateway includes identification information ‘0x10’, the gateway may transmit the test mode request signal to a first communication node corresponding to the identification information ‘0x10’ by referring to the information of Table 1.

Meanwhile, in addition to the identification information of the communication node, the test mode request signal may further comprise mode type information indicating a test mode of the compliance test to be performed on the communication node. That is, the mode type information indicates a type of test mode to be performed. Here, the mode type information may be information of a register code value to be configured in a register of the communication node to be tested. For example, register code values indicating test modes may be configured as represented in Table 2 below.

TABLE 2

| Mode type information | Code value | Description |
|---|---|---|
| Test Mode 1 | 0x2200 | Transmit droop test mode |
| Test Mode 2 | 0x4200 | Transmit jitter test in MASTER mode |
| Test Mode 3 | 0x6000 | Transmit jitter test in SLAVE mode |
| Test Mode 4 | 0x8200 | Transmit distortion mode |
| Test Mode 5 | 0xA200 | Power Spectral Density mask and |
| | | power level test mode |

The mode type information included in the test mode request signal may be information indicating one of test modes listed in the Table 2. For example, if the mode type information included in the test mode request signal indicates ‘0x2200’, the gateway may transmit the code value ‘0x2200’ to the communication node corresponding to the identification information as included in the test mode request signal.

After the step S302, the communication node may receive the test mode request signal on the communication node from the gateway (S304). The test mode request signal received at the communication node includes the mode type information for the compliance test.

After the step S304, the communication node may generate an output signal according to the received test mode request signal (S306). The communication node may generate the output signal corresponding to the mode type information included in the received test mode request signal. For this, the communication node may store table information on mode type information for compliance test (e.g., the above-described Table 2).

When the mode type information included in the received test mode request signal indicates the code value ‘0x2200’ of Table 2, the communication node may generate an output signal of ‘Droop test’ corresponding to the code value ‘0x2200’. The ‘Droop test’ is a test for verifying whether voltage levels corresponding to continuous ‘+1’ or ‘−1’ are maintained stably in serial communications. If the code value ‘0x2200’ is received, the communication node is transitioned to a test mode 1. Accordingly, the communication node may generate the predetermined number (e.g., n) of signals ‘+1’ or ‘−1’ for the Droop test. Such the signals ‘+1’ or ‘−1’ correspond to test symbols according to the Droop test.

Also, when the mode type information included in the received test mode request signal indicates the code value ‘0x4200’ of the table 2, the communication node may generate an output signal of ‘transmit jitter test in master mode’ corresponding to the code value ‘0x4200’. The ‘jitter test’ is a test for verifying whether a signal is output as preceding or delayed in reference to an ideal reference time. Thus, if a value output from the ‘jitter test’ is large, an error that signals cannot be transmitted with specific timing may occur. Upon receiving the code value ‘0x4200’, the communication node is transitioned to a test mode 2. Accordingly, the communication node may generate test symbols ‘+1’ and ‘−1’ in a master mode.

Also, when the mode type information included in the received test mode request signal indicates the code value ‘0x6000’ of the table 2, the communication node may generate an output signal of ‘transmit jitter test in slave mode’ corresponding to the code value ‘0x6000’. Upon receiving the code value ‘0x6000’, the communication node is transitioned to a test mode 3. Accordingly, the communication node may generate test symbols ‘+1’ and ‘−1’ in a slave mode.

Also, when the mode type information included in the received test mode request signal indicates the code value ‘0x8200’ of the table 2, the communication node may generate an output signal of ‘transmit distortion test’ corresponding to the code value ‘0x8200’. The ‘distortion test’ is a test for verifying whether a vehicle network operates correctly even when external distortion signals exist. Upon receiving the code value ‘0x8200’, the communication node is transitioned to a test mode 4. Accordingly, the communication node may generate test symbols for the distortion test.

Also, when the mode type information included in the received test mode request signal indicates the code value ‘0xA200’ of the table 2, the communication node may generate an output signal of ‘power spectral density (PSD) test’ corresponding to the code value ‘0xA200’. The ‘PSD test’ is a test for verifying a voltage level by transmitting test symbols ‘+1’ and ‘−1’ with full power. Upon receiving the code value ‘0xA200’, the communication node is transitioned to a test mode 5. Accordingly, the communication node may generate test symbols for the PSD test.

After the step S306, the communication node may transmit the generated output signal to the gateway (S308). The communication node may transmit the output signal to the gateway having transmitted the test mode request signal by using a communication manner such as DoIP or SOME/IP. For example, as illustrated in Table 2, the communication node may transmit to the gateway an output signal corresponding to one of ‘Droop test’, litter test in master mode′, litter test in slave mode′, ‘Distortion test’, and ‘Power Spectral Density test’.

After the step S308, the gateway may receive the output signal corresponding to the test mode request signal from the communication node (S310). The gateway may receive the output signal corresponding to the mode type information of the test mode request signal.

After the step S310, the gateway may transmit the received output signal to a fixture connected to a test apparatus (S312). The gateway may transmit the output signal to the fixture by using a communication manner DoIP or SOME/IP.

After the step S312, the fixture may transmit the output signal received from the gateway to the test apparatus, and the test apparatus may output a test result based on the output signals received from the fixture (S314, S316).

For example, when the predetermined number n of test symbols ‘+1’ and ‘−1’ according to the Droop test are received from the fixture, the test apparatus may determine whether periodicity for the n test symbols is maintained during a predetermined period of time. That is, the test apparatus may measure maximum voltage value of a wage generated by the test symbols, and a voltage value after a lapse of a predetermined time from the maximum voltage value. If a ratio of the maximum voltage value to the voltage value measured after a lapse of the predetermined time is within a predetermined threshold (e.g., 50%), the test apparatus may determine the result of the Droop test on test symbols ‘+1’ as normal. In such the manner, the test apparatus may measure minimum voltage value of a wage generated by the test symbols, and a voltage value after a lapse of a predetermined time from the minimum voltage value. If a ratio of the minimum voltage value to the voltage value measured after a lapse of the predetermined time is within a predetermined threshold, the test apparatus may determine the result of the Droop test on test symbols ‘−1’ as normal. When the test results of the Droop test on both of test symbols ‘+1’ and ‘−1’ are determined as normal, the test apparatus may output a test result indicating that the result of the Droop test on the communication node is successful.

Also, when the test symbols ‘+1’ and ‘−1’ according to the jitter test in master mode are continuously received from the fixture, the test apparatus may measure a bit rate of the test symbols of the communication node in master mode. The test symbols outputted by the communication node may be usual non-return to zero (NRZ) signals. The test apparatus may measure the bit rate by receiving the test symbols which are NRZ signals. The test apparatus may measure how much time differences between respective edges of the signals occur based on the measured bit rate, and output a result on a waveform of the measured value and the compliance test.

Also, when the test symbols ‘+1’ and ‘−1’ according to the jitter test in slave mode are continuously received from the fixture, the test apparatus may measure a bit rate of the test symbols of the communication node in slave mode. The test apparatus may output a result on the compliance test on the communication node in slave mode based on the measured bit rate.

Also, when the test symbols and distortion signal according to the distortion test are received from the fixture, the test apparatus may output a result on whether signals of the communication node are distorted according to the distortion signal. For the distortion test, an arbitrary waveform generator for inputting the distortion signal is required. The arbitrary waveform generator should be clock-synchronized with the test apparatus. The fixture may be connected to the arbitrary waveform generator. Upon receiving the test symbols, the fixture may transmit to the test apparatus the distortional signal generated by the generator and the output signal received from the gateway. When the output signal and distortion signal are received, the test apparatus may filter the distortion signal from the output signal and the distortion signal. If a component of the filtered distortion signal is represented below a predetermined voltage level, the test apparatus may output a result indicating that distortion of the communication node is normal.

Also, when the test symbols with full power according to the PSD test are received from the fixture, the test apparatus may output a result of the PSD test on the communication node by determining whether the test symbols with full power stray from a predetermined PSD mask. Here, information on the PSD mask is configured beforehand as table information of PSD masks for respective frequency bands.

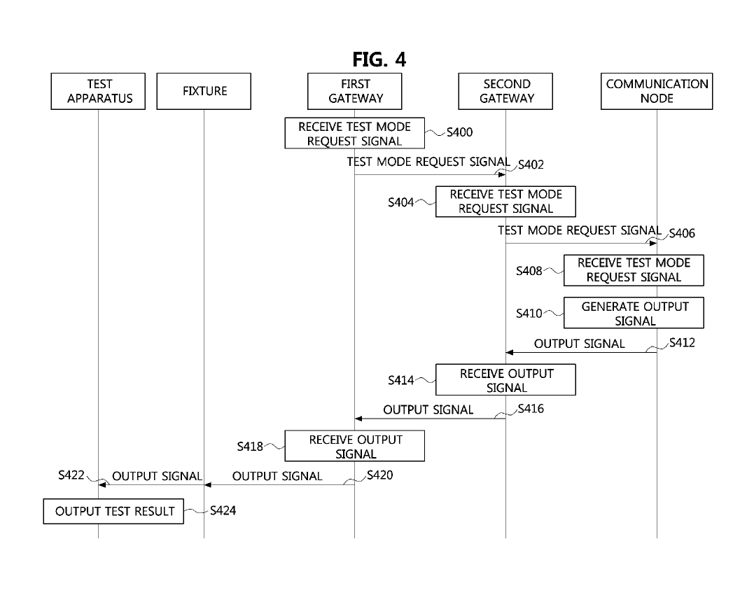

FIG. 4 is a sequence chart illustrating an additional compliance test method in a gateway and a communication node constituting a vehicle network according to embodiments of the present disclosure.

As shown in FIG. 4, a compliance test method using at least two gateways (e.g., a first gateway and a second gateway) is illustrated. The network compositions, communication manners, transmit/receive information, etc. of the case of FIG. 4 are identical or similar to those of the case of FIG. 3. Thus, redundant explanations may be omitted.

The first gateway may receive a test mode request signal for a communication node (S400).

After the step S400, the first gateway may transmit a test mode request signal to the second gateway connected to the communication node corresponding to the received test mode request signal (S402). The first gateway may transmit the test mode request signal to the second gateway by using a communication manner such as DoIP or SOME/IP.

The received test mode request signal may include identification information of the communication node to be tested among a plurality of communication nodes which are directly connected to the first gateway. Also, the test mode request signal may include identification information of the communication to be tested which is not directly connected to the first gateway but connected to one (e.g., the second gateway) of other gateways connected to the first gateway. Thus, if the communication node corresponding to the identification information of the test mode request signal is connected to not the first gateway but the second gateway, the first gateway may transmit the test mode request signal to the second gateway. For this, the first gateway may store, in advance, table information on identification information of communication nodes which are directly connected to the first gateway and communication nodes which are connected to other gateways connected to the first gateway. For example, Table 3 below may show an example of a table having information on communication nodes and gateways connected to the communication nodes.

TABLE 3

| Communication node | Identification Information | Connected gateway |
|---|---|---|
| 1 | 0x10 | Gateway 1 |
| 2 | 0x20 | Gateway 1 |
| 3 | 0x30 | Gateway 1 |
| 4 | 0x40 | Gateway 1 |
| 5 | 0x50 | Gateway 2 |
| 6 | 0x60 | Gateway 2 |
| 7 | 0x70 | Gateway 3 |

For example, if the received test mode request signal includes one of the identification information ‘0x10’, ‘0x20’, ‘0x30’, and ‘0x40’, the first gateway may directly transmit the test mode request signal to one of communication nodes which corresponds to the identification information included in the received test mode request signal by referring to the information of Table 3. However, if the received test mode request signal includes one of ‘0x50’ and ‘0x60’, the first gateway cannot directly transmit the test mode request signal to a communication node (i.e., a fifth communication node or a sixth communication node) corresponding to the identification information 0x50 or 0x60. Instead, the first gateway may transmit the test mode request signal to the second gateway connected to the fifth and sixth communication nodes.

After the step S402, the second gateway may receive the test mode request signal on the communication node from the first gateway (S404).

After the step S404, the second gateway may transmit the test mode request signal to the communication node corresponding to the received test mode request signal (S406). In order to transmit the test mode request signal to the communication node corresponding to the received test mode request signal, the second gateway may also store the identification information on communication nodes as represented in Table 3.

After the step S406, the communication node may receive the test mode request signal from the second gateway (S408). The test mode request signal received by the communication node may include mode type information indicating a test mode for compliance testing.

After the step S408, the communication node may generate an output signal corresponding to the received test mode request signal (S410). The communication node may generate an output signal corresponding to the mode type information included in the received test mode request signal. For this, the communication node may a register in the communication node with the code value corresponding to the mode type information as represented in Table 2.

After the step S410, the communication node may transmit the generated output signal to the second gateway (S412). The communication node may transmit the generated output signal to the second gateway having transmitted the test mode request signal.

After the step S412, the second gateway may receive the output signal from the communication node (S414). The second gateway may receive the output signal corresponding to the mode type information included in the test mode request signal.

After the step S414, the second gateway may transmit the output signal to the first gateway (S416). The second gateway may transmit the output signal to the first gateway having transmitted the test mode request signal. The second gateway may transmit the output signal to the first gateway by using a communication manner such as DoIP or SOME/IP.

After the step S416, the first gateway may receive the output signal from the second gateway (S418). The first gateway may receive the output signal corresponding to the mode type information included in the test mode request signal.

After the step S418, the first gateway may transmit the received output signal to the fixture connected to the test apparatus (S420).

After the step S420, the fixture may transmit the output signal received from the first gateway to the test apparatus, and the test apparatus may output a test result based on the output signal received from the fixture (S422, S424). When the output signal is received from the fixture, the test apparatus may output an output waveform and a test result corresponding to the received output signal.

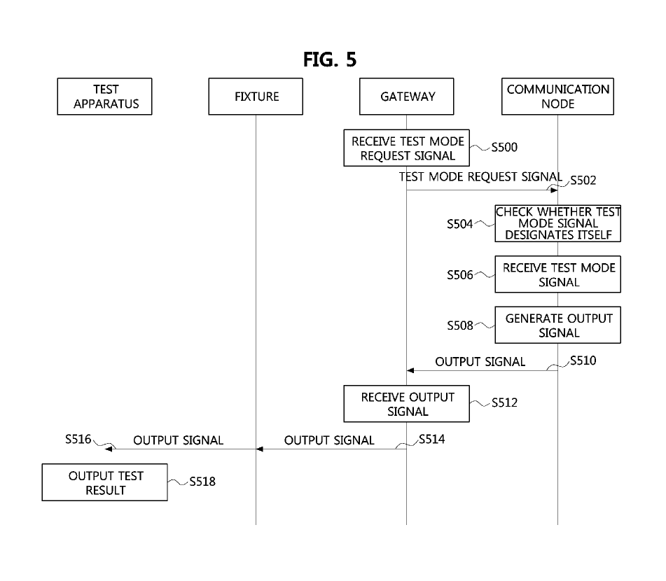

FIG. 5 is a sequence chart illustrating an additional compliance test method in a gateway and a communication node constituting a vehicle network according to embodiments of the present disclosure.

As shown in FIG. 5, a compliance test method using a single gateway is illustrated. The gateway may receive a test mode request signal for a compliance test on at least one communication node (S500). The test mode request signal may be received from a computer connected to the gateway or a test apparatus for the compliance test. The gateway may receive the test mode request signal by using a communication manner such as DoIP or SOME/IP.

The received test mode request signal may include identification information of at least one communication node on which the compliance test is performed among a plurality of communication nodes connected to the gateway. Also, in addition to identification information of at least one communication node, the test mode request signal may further comprise mode type information indicating a test mode of the compliance test. Here, the mode type information may be information of a register code value to be configured in a register of the communication nodes to be tested.

After the step S500, the gateway may transmit the test mode request signal to at least one communication node connected to the gateway (S502). The gateway may broadcast the test mode request signal to all of the communication nodes connected to the gateway. The gateway may transmit the test mode request signal to all of the communication nodes by using a communication manner such as DoIP or SOME/IP.

After the step S502, the communication node may determine whether the test mode request signal transmitted by the gateway designates itself or not (S504). That is, the communication node may check whether the test mode request signal designates itself or not based on the identification information included in header information of the test mode request signal. If the identification information indicated by the test mode request signal coincides with its identification information, the communication node may determine that the test mode request signal designates itself. However, if the identification information indicated by the test mode request signal does not coincide with its identification information, the communication node may determine that the test mode request signal does not designate itself. If it is determined that the test mode request signal does not designate it, the communication node may ignore the test mode request signal transmitted by the gateway.

After the step S504, if it is determined that the test mode request signal designates the communication node, the communication node may identify the test mode request signal from the gateway (S506). The test mode request signal received at the communication node may include the mode type information indicating a test mode.

After the step S506, the communication node may generate an output signal according to the received test mode request signal (S508). The communication node may generate the output signal corresponding to the mode type information included in the received test mode request signal. The communication node may configure its register with the code value received as the mode type information.

After the step S508, the communication node may transmit the generated output signal to the gateway (S510). The communication node may transmit the output signal to the gateway having transmitted the test mode request signal by using a communication manner DoIP or SOME/IP.

After the step S510, the gateway may receive the output signal corresponding to the test mode request signal from the communication node (S512). The gateway may receive the output signal corresponding to the mode type information of the test mode request signal.

After the step S512, the gateway may transmit the received output signal to a fixture connected to a test apparatus (S514). The gateway may transmit the output signal to the fixture by using a communication manner DoIP or SOME/IP.

After the step S514, the fixture may transmit the output signal received from the gateway to the test apparatus, and the test apparatus may output a test result based on the output signals received from the fixture (S516, S518). When the output signal is received from the fixture, the test apparatus may output an output waveform and a test result corresponding to the received output signal.

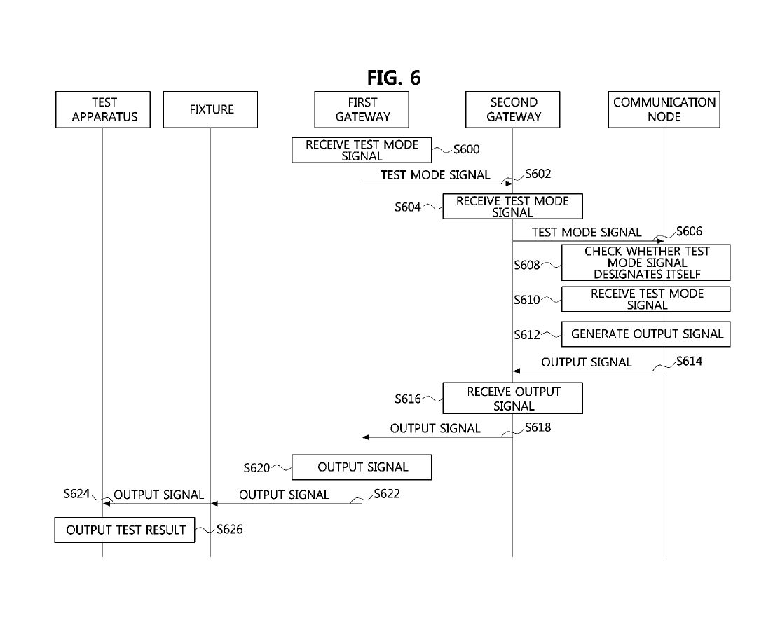

FIG. 6 is a sequence chart illustrating an additional compliance test method in a gateway constituting a vehicle network according to embodiments of the present disclosure.

As shown in FIG. 6, a compliance test method using at least two gateways (e.g., a first gateway and a second gateway) is illustrated. The network compositions, communication manners, transmit/receive information, etc. of the case of FIG. 6 are identical or similar to those of the case of FIG. 5. Thus, redundant explanations may be omitted.

The first gateway may receive a test mode request signal for a communication node (S600).

After the step S600, the first gateway may transmit the test mode request signal to at least one other gateway connected to the first gateway (e.g., the second gateway) (S602). That is, the first gateway may broadcast the test mode request signal to all of the communication nodes connected to the first gateway, and also broadcast the test mode request signal to all of other gateways (e.g., the second gateway) connected to the first gateway. The first gateway may transmit the test mode request signal to the second gateway by using a communication manner such as DoIP or SOME/IP.

After the step S602, the second gateway may receive the test mode request signal on the communication node from the first gateway (S604).

After the step S604, the second gateway may transmit the test mode request signal to all of the communication nodes connected to the second gateway (S606). That is, the second gateway may broadcast the test mode signal to all of the communication nodes connected to the second gateway.

After the step S606, the communication node may determine whether the test mode request signal transmitted by the second gateway designates itself or not (S608). The test mode request signal may include identification information on a communication node to be tested among the communication nodes connected to the second gateway. Thus, the communication node may check whether the test mode request signal designates itself or not based on the identification information included in header information of the test mode request signal.

After the step S608, if it is determined that the test mode request signal designates the communication node, the communication node may identify the test mode request signal from the second gateway (S610). The test mode request signal received at the communication node may include the mode type information indicating a test mode.

After the step S610, the communication node may generate an output signal according to the received test mode request signal (S612). The communication node may generate the output signal corresponding to the mode type information included in the received test mode request signal. The communication node may configure its register with the code value received as the mode type information.

After the step S612, the communication node may transmit the generated output signal to the second gateway (S614). The communication node may transmit the output signal to the second gateway having transmitted the test mode request signal.

After the step S614, the second gateway may receive the output signal corresponding to the test mode request signal from the communication node (S616). The gateway second may receive the output signal corresponding to the mode type information of the test mode request signal.

After the step S616, the second gateway may transmit the received output signal to the first gateway (S618). The second gateway may transmit the output signal to the first gateway having transmitted the test mode request signal. The second gateway may transmit the output signal to the first gateway by using a communication manner such as DoIP or SOME/IP.

After the step S618, the first gateway may receive the output signal from the second gateway (S620). The first gateway may receive the output signal corresponding to the mode type information included in the test mode request signal.

After the step S620, the first gateway may transmit the received output signal to the fixture connected to the test apparatus (S622).

After the step S622, the fixture may transmit the output signal received from the first gateway to the test apparatus, and the test apparatus may output a test result based on the output signal received from the fixture (S624, S626). When the output signal is received from the fixture, the test apparatus may output an output waveform and a test result corresponding to the received output signal.

The compliance tests on a communication node, explained by referring to FIGS. 3 to 6, can be performed not as it is a component which is not installed in a vehicle but as it is installed in a vehicle. That is, since various compliance tests on a communication become possible as the communication node is installed in a vehicle, it is not necessary to disassemble the vehicle for compliance testing.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

Alternatively, the communication node may adjust the size of a reserved bandwidth in case that a part of the bandwidth reserved for transmitting the first frame needs to be used for a third frame (e.g., a frame including a data unit generated based on TCP/IP). In other words, the communication node may reduce the size of a reserved bandwidth. Thus, the communication node may transmit the first frame through the reduced bandwidth and may transmit the third frame through the rest of the total bandwidth. The communication node may initialize the reduced bandwidth (i.e., increase the size of bandwidth) upon completing transmission of the second frame and may transmit the first frame through the initialized bandwidth.

While the embodiments of the present disclosure and their advantages have been described in detail above, it should be understood that various changes, substitutions and alterations may be made herein without departing from the scope of the disclosure. Thus, the disclosed embodiments are intended to cover various modifications and equivalent arrangements included within the spirit and scope of the appended claims.

What is claimed is:

1. A method for a compliance test on a communication node, performed in a gateway constituting a vehicle network of a vehicle, the method comprising:
receiving a test mode request signal for the compliance test on the communication node;
transmitting the test mode request signal to the communication node on which the compliance test is performed;
receiving an output signal according to the test mode request signal from the communication node; and
transmitting the received output signal to a fixture connected to a test apparatus which performs the compliance test on the communication node.

2. The method according to claim 1, wherein the test mode request signal includes identification information of the communication node, and the test mode request signal is transmitted to the communication node according to the identification information of the communication node.

3. The method according to claim 1, wherein, when the communication node is connected to another gateway that is connected to the gateway, the test mode request signal is transmitted to the communication node through the other gateway.

4. The method according to claim 1, wherein the test mode request signal includes mode type information indicating a type of the compliance test.

5. The method according to claim 4, wherein the mode type information includes a code value to be configured in a register of the communication node.

6. The method according to claim 4, wherein the gateway receives an output signal corresponding to the mode type information from the communication node, and transmits the received output signal to the fixture.

7. The method according to claim 4, wherein the output signal includes test symbols corresponding to the mode type information.

8. The method according to claim 1, wherein the compliance test is performed as the communication node is installed in the vehicle.

9. A method for a compliance test on a communication node constituting a vehicle network of a vehicle, the method comprising:
receiving a test mode request signal for the compliance test on the communication node from a gateway;
generating an output signal according to the received test mode request signal; and
transmitting the generated output signal to the gateway.

10. The method according to claim 9, wherein the generated output signal corresponds to mode type information included in the test mode request signal.

11. The method according to claim 10, wherein the mode type information includes a code value to be configured in a register of the communication node.

12. The method according to claim 9, wherein the compliance test is performed as the communication node is installed in the vehicle.

13. A method for a compliance test on a communication node, performed in a gateway constituting a vehicle network of a vehicle, the method comprising:
receiving a test mode request signal for the compliance test on the communication node;
transmitting the received test mode request signal respectively to at least one communication node connected to the gateway on which the compliance test is performed;
receiving an output signal according to the test mode request signal from the at least one communication node which received the test mode request signal; and
transmitting the received output signal to a fixture connected to a test apparatus which performs the compliance test on the communication node.

14. The method according to claim 13, wherein, when the at least one communication node is connected to another gateway that is connected to the gateway, the test mode request signal is transmitted to the at least one communication node through the other gateway.

15. The method according to claim 13, wherein the test mode request signal includes mode type information indicating a type of the compliance test.

16. The method according to claim 15, wherein the mode type information includes a code value to be configured in a register of the communication node.

17. A method for a compliance test on a communication node constituting a vehicle network of a vehicle, the method comprising:
determining whether a test mode request signal transmitted from a gateway designates the communication node;
identifying the test mode request signal when the test mode request signal designates the communication node;
generating an output signal according to the identified test mode request signal; and
transmitting the generated output signal to the gateway.

18. The method according to claim 17, wherein the communication node determines whether the test mode request signal designates the communication node based on identification information included in the test mode request signal.

19. The method according to claim 17, wherein the generated output signal corresponds to mode type information included in the test mode request signal.

20. The method according to claim 19, wherein the mode type information includes a code value to be configured in a register of the communication node.
